(19) United States
(12) Patent Application Publication
(10) Pub. No.: US 2026/0187686 A1
(43) Pub. Date: Jul. 2, 2026

(54) Systems and Methods for Integrated Lending Tools

(71) Applicant: The PNC Financial Services Group, Inc., Pittsburgh, PA (US)

(72) Inventors: Michael LOZANO, Pittsburgh, PA (US); Christopher LOPEZ, Pittsburgh, PA (US); Michael HOWARTH, Pittsburgh, PA (US); Nick WILSON, Pittsburgh, PA (US)

(21) Appl. No.: 19/303,617

(22) Filed: Aug. 19, 2025

Related U.S. Application Data
(60) Provisional application No. 63/684,520, filed on Aug. 19, 2024.
(60) Provisional application No. 63/684,523, filed on Aug. 19, 2024.
(60) Provisional application No. 63/684,525, filed on Aug. 19, 2024.

(51) Int. Cl. G06Q 30/0283; G06Q 40/03

(52) U.S. Cl. CPC G06Q 30/0283; G06Q 40/0305; G06Q 40/033

(57) ABSTRACT

Systems and methods are provided for creating, storing, and using data received from a user via a first network entity. The data can include elements that affect the product offerings that may be generated by an institution, and the received data can be stored as a data package on a second network entity. A first product offering may be generated at a first point in time by applying a pricing engine to the data package. Similarly, at a second point in time, a second product offering can be automatically generated by applying the pricing engine to the data package.

### CROSS-REFERENCE TO RELATED APPLICATIONS

This application claims priority to U.S. Provisional Application No. 63/684,520, filed Aug. 19, 2024, U.S. Provisional Application No. 63/684,523, filed Aug. 19, 2024, and U.S. Provisional Application No. 63/684,525, filed Aug. 19, 2024, the entirety of all of which are herein incorporated by reference.

### BACKGROUND

Prospective home buyers, like individuals or families, often research the housing market, evaluate their financial readiness, and explore available properties when considering a home purchase. Financial institutions, such as a bank or credit union, play a central role in the homebuying process by offering a range of mortgage products that allow the financial institution to lend the home buyer the funds necessary to buy the property. When an individual or family decides to purchase a home, they typically approach a financial institution to apply for a loan that will finance the purchase. The process can involve an application, during which the institution collects detailed information about the applicant's financial situation, including income, employment history, credit score, existing debts, and assets. This information is often used to assess the borrower's creditworthiness and determine the amount they are eligible to borrow. Financial institutions can provide pre-qualification and pre-approval services, which give buyers an estimate of how much they can afford and strengthen their position when making an offer on a property. Once a suitable property is found, the buyer then submits a formal mortgage application, and the institution conducts a thorough underwriting process to evaluate the risk and finalize the loan terms.

Throughout this process, financial institutions offer a variety of mortgage options to suit different financial situations and preferences. Common products include fixed-rate mortgages, where the interest rate remains constant over the life of the loan, and adjustable-rate mortgages, where the rate may change periodically based on market conditions. Lenders may also offer government-backed loans, such as FHA, VA, or USDA loans, which are designed to help specific groups of buyers or those with lower down payments. In addition to the loan itself, financial institutions sometimes offer educational resources to help borrowers understand the long-term implications of their choices.

### SUMMARY

Systems and methods are provided for creating, storing, and using dynamic lending scenarios to assist prospective home buyers in evaluating mortgage product offerings from a financial institution. These dynamic lending scenarios may allow a user to simultaneously analyze multiple different lending product offerings from a number of different scenarios, and may be stored and automatically updated at a later point in time to account for current interest rates and lending offerings from the financial institution. In this manner, a user may evaluate lending product offerings generated from one or more lending scenarios at a first location and point in time, and then return and access new lending product offerings at a second location and second point in time on their account. Additionally, the dynamic lending scenarios may be integrated into a mortgage planner dashboard that has a number of interactive tools to assist with the home purchasing process. The tools may communicate relevant financial information with one another, such that the tools may be personalized based on information received from a user, thereby providing a tailored home purchasing experience. The mortgage planner dashboard may thereby draw from disparate information sources to create a custom resource that allows a prospective purchaser to conduct home ownership research all in one place.

In one aspect, the present disclosure provides one or more computer storage media storing computer-readable instructions that when executed by one or more processors, cause the one or more processors to perform operations. The operations may include receiving financial data from a user via a first network entity, the financial data including elements that affect the lending product offerings that may be provided by a financial institution to a prospective purchaser; storing, via a second network entity, a lending scenario that includes the financial data; generating, at a first point in time, a first lending product offering by applying a pricing engine to the lending scenario; and automatically generating, at a second point in time, a second lending product offering by applying the pricing engine to the lending scenario.

In another aspect, the present disclosure provides a computer-implemented method for generating personalized home purchasing tools. The method may include receiving, via a processor, financial information provided by a user while accessing a first interactive tool associated with home purchasing; storing the financial information received from the first interactive tool in a data store; modifying, via a processor, a second interactive tool associated with home purchasing based on the stored financial information; and providing, via a processor, access to the modified second interactive tool to the user.

In yet another aspect, the present disclosure provides a system for generating personalized home purchasing tools. The system may include means for receiving financial information provided by a user while accessing a first interactive tool associated with home purchasing; means for storing the financial information received from the first interactive tool; means for modifying a second interactive tool associated with home purchasing based on the stored financial information; and means for providing the user access to the modified second interactive tool.

The current subject matter will be better understood by reference to the following detailed description when considered in combination with the accompanying drawings, which form part of the present specification.

### DESCRIPTION OF DRAWINGS

FIG. 1A is a diagram depicting the generation of product offerings from a stored data element, the product offerings for use in a first network entity micro application.

FIG. 1B is a diagram depicting the generation of lending product offerings from a stored lending scenario, the lending product offerings for use in a scenario builder micro application.

FIG. 2 is a flowchart of a method of generating of lending product offerings from a stored lending scenario.

FIG. 3 is a diagram depicting a banking system handling the generation of a plurality of lending scenarios based on financial information supplied through various users.

FIG. 4 is a diagram depicting a banking system having a mortgage planner dashboard system that communicates with various network entities to provide several interactive home purchasing tools.

FIG. 5 is a flowchart of a method of generating personalized home purchasing tools.

FIG. 6 is a diagram depicting the generation of a personalized home search micro application using information received from a scenario builder micro application.

FIG. 7A is a diagram depicting a graphical user interface displaying a home page of a mortgage planner dashboard system having several integrated interactive tools.

FIG. 7B is a diagram depicting the graphical user interface of FIG. 7A, with the mortgage planner dashboard system displaying prior lending product information associated with a user.

FIG. 8 is a diagram depicting an “Estimated Credit Score” tool of the mortgage planner dashboard system of FIG. 7A.

FIG. 9A is a diagram depicting a user input page of a “Mortgage Payment Calculator” tool of the mortgage planner dashboard system of FIG. 7A.

FIG. 9B is a diagram depicting an estimated results page of the “Mortgage Payment Calculator” tool of the mortgage planner dashboard system of FIG. 7A.

FIG. 10A is a diagram depicting a start page of a “Scenario Builder” tool of the mortgage planner dashboard system of FIG. 7A.

FIG. 10B is a diagram depicting a first user input page of a “Scenario Builder” tool of the mortgage planner dashboard system of FIG. 7A.

FIG. 10C is a diagram depicting a second user input page of a “Scenario Builder” tool of the mortgage planner dashboard system of FIG. 7A.

FIG. 10D is a diagram depicting a third user input page of a “Scenario Builder” tool of the mortgage planner dashboard system of FIG. 7A.

FIG. 10E is a diagram depicting a fourth user input page of a “Scenario Builder” tool of the mortgage planner dashboard system of FIG. 7A.

FIG. 10F is a diagram depicting a fifth user input page of a “Scenario Builder” tool of the mortgage planner dashboard system of FIG. 7A.

FIG. 10G is a diagram depicting a sixth user input page of a “Scenario Builder” tool of the mortgage planner dashboard system of FIG. 7A.

FIG. 10H is a diagram depicting a seventh user input page of a “Scenario Builder” tool of the mortgage planner dashboard system of FIG. 7A.

FIG. 10I is a diagram depicting a scenario listing page of a “Scenario Builder” tool of the mortgage planner dashboard system of FIG. 7A.

FIG. 10J is a diagram depicting a mortgage offerings listing page of “Scenario 1” within the “Scenario Builder” tool of the mortgage planner dashboard system of FIG. 7A.

FIG. 10K is a diagram depicting the graphical user interface of FIG. 7A, with the mortgage planner dashboard system now displaying information associated with a generated lending scenario.

FIG. 11A is a diagram depicting a start page of a “Home Search” tool of the mortgage planner dashboard system of FIG. 7A.

FIG. 11B is a diagram depicting a search page of a “Home Search” tool of the mortgage planner dashboard system of FIG. 7A.

FIG. 11C is a diagram depicting the search page of FIG. 11B with a selected property marked as a favorite.

FIG. 11D is a diagram depicting a property listing page of a “Home Search” tool of the mortgage planner dashboard system of FIG. 7A.

FIG. 11E is a diagram depicting a financial information associated with a property listing page of a “Home Search” tool of the mortgage planner dashboard system of FIG. 7A.

FIG. 11F is a diagram depicting a property listing search parameters page of a “Home Search” tool of the mortgage planner dashboard system of FIG. 7A.

FIG. 12 is a diagram depicting a start page of a “Calculators” tool of the mortgage planner dashboard system of FIG. 7A.

FIG. 13 is a diagram depicting an example system for implementing the approaches described herein for underwriting task control and assignment.

### DESCRIPTION

The following disclosure provides many different aspects, or examples, for implementing different features of the provided subject matter. Specific examples of components and arrangements are described below to simplify the present disclosure. These are, of course, merely examples and are not intended to be limiting.

As discussed above, to assist with the home buying process, financial institutions can provide offers and/or preapproval for a variety of mortgage options to suit different financial situations. Financial institutions, as well as other online resources, may also offer various lending tools to assist with the home buying process. As a result, researching a home purchase can mean that a prospective purchaser (i.e., potential buyer) is forced to juggle a patchwork of financial resources, applications, and tools, which can make the process inefficient and overwhelming. For example, prospective purchasers may start by researching property listings on home search sites (e.g., Zillow, Redfin, etc.). For loan shopping, prospective purchasers may then have to switch to bank or broker websites, rate-comparison tools, or mortgage calculators—each with its own assumptions, fees, and limitations. In particular, obtaining real-time estimates of mortgage offerings is challenging because rates change frequently based on market conditions, lender policies, and borrower-specific factors like credit score, income, and down payment size. Online mortgage calculators typically rely on static or delayed data, so the lending offerings may be outdated by the time a prospective purchaser actually contacts a lender. Budgeting may add yet another layer, requiring separate spreadsheets or financial planning apps to factor in taxes, insurance, maintenance, and closing costs. The present disclosure recognizes that, because none of these tools seamlessly integrate listings, real-time mortgage offers, and personalized budgeting in one place, buyers are forced to constantly cross-reference numbers, re-enter information, and reconcile conflicting data, resulting in a protracted and overwhelming home buying experience.

The present disclosure addresses the aforementioned drawbacks, as well as others, by providing systems and methods that allow prospective purchasers to easily navigate the home buying process. In particular, a mortgage planner dashboard may store and share financial information of users across multiple interactive tools relevant to the home buying process, thereby tailoring each tool to the user's specific financial situation and interests. The financial data associated with each user, as well as specific lending scenarios generated using information received from each user, may also be stored and associated with a user account. In this manner, a user may easily return to the mortgage planner dashboard at a later point in time (e.g., the next day), and the scenario planner may automatically recalculate the personalized lending product offerings available to a user based on their provided scenarios, as will be further described. Given that the mortgage planner dashboard tools may be seamlessly accessed at different points in time and from different devices through a user's account and the stored personal information and lending scenarios associated therewith, processes associated with home buying may become more efficient. For instance, a mortgage broker or loan officer may access a prospective purchaser's mortgage planner dashboard account on their behalf and save lending scenarios based on discussions with the prospective purchaser on a first device (e.g., a computer at a bank branch location); the prospective purchaser may then later access, review, and edit the same stored lending scenarios using the mortgage planner dashboard (e.g., on a cellular device at their home), and vice versa.

It should be recognized that, while many examples of the present disclosure relate to example consumer home buying tools, the systems and methods discussed herein are applicable in numerous other scenarios, including any situation where a lending product is being issued with respect to property and a prospective purchaser desires to review their lending options.

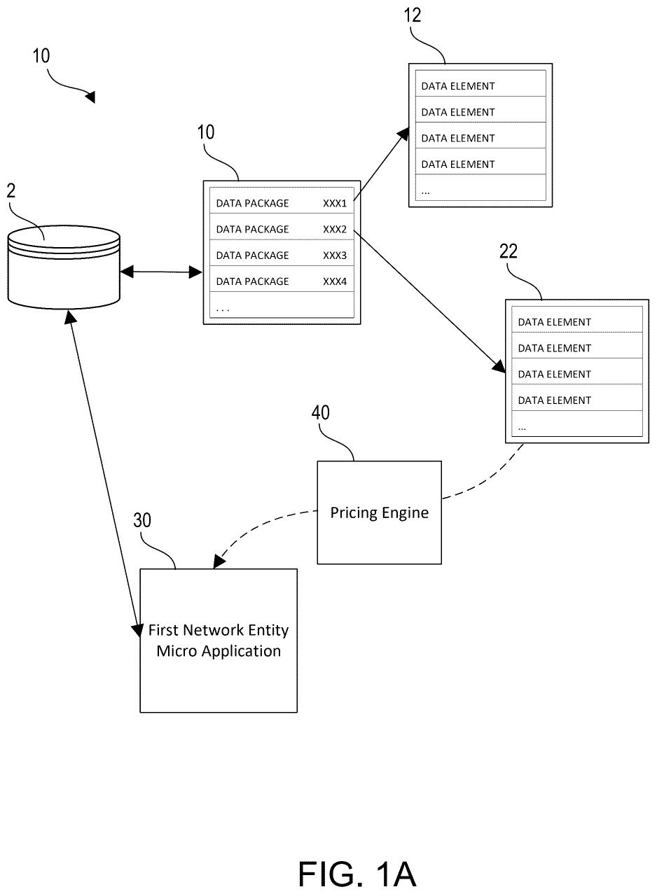

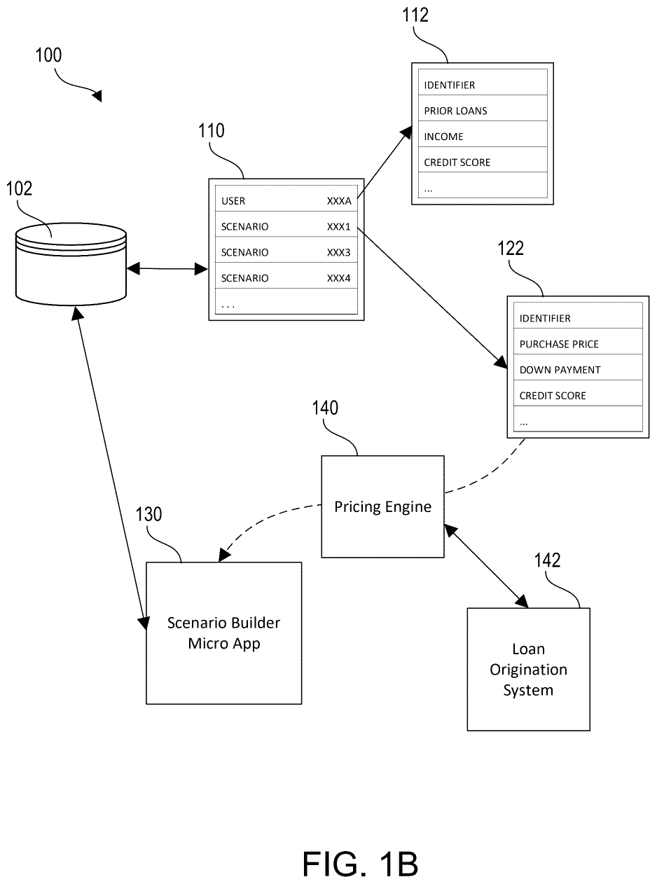

FIG. 1A depicts a system 10 for the generation of product offerings from a stored data package, which may be used in a micro application 30 of a first network entity. As shown, the micro application 30 may transfer information to data store 2, which may house information 10 received from the micro application 30. For instance, the data store 2 may house inputs and user information contained within a first data package 12 and a second data package 22, and may use a pricing engine 40 to generate product offerings. As will be further described, the stored data packages 10 may also rely on information received from various other network entities, and, in addition to the generation of product offerings, may facilitate the customization of other network entities, including other micro applications.

Similar to FIG. 1A, FIG. 1B depicts a system 100 for the generation of lending product offerings from a stored lending scenario, which may be used in a scenario builder micro application 130, such as by displaying the lending offerings to a user of the scenario builder micro application 130. As shown, the scenario builder micro application 130 may transfer information to data store 102, which may house information 110 associated with one or more users of the micro application 130. For instance, the data store 102 may house user information 112, such as an identifier, income, credit score, and other financial information about a prospective purchaser. As will be further described, this user information 112 may be received from the scenario builder micro application 130, from other micro applications associated with a mortgage planner dashboard system, or from ancillary systems associated with a financial institution. For example, the data store may receive information regarding prior lending accounts of one or more users, and may store this information as user information that is accessible to the scenario builder micro application 130.

The data store 102 may also house one or more lending scenarios, which may include scenario information 122 that is used to produce a lending product offering that may be presented to a user via the scenario builder micro application 130. For instance, each lending scenario, which may include a unique identifier, may house financial information used to determine lending product offerings, such as a maximum purchase price of a property, a down payment value (e.g., amount, percentage), a credit score, as well as other information. This financial information may be provided by a user of the scenario builder micro application, and stored in discrete lending scenario groupings within the data store 102. By associating specific lending scenarios with a user's account, a user of the scenario builder micro application 130 may generate and compare the lending product offerings available to them for a variety of different lending scenarios (e.g., different purchase prices, down payment values, credit scores, lending product goals, etc.). Moreover, the scenario builder micro application may be configured to generate the lending product offerings using the scenarios stored in the data store 102 each time a user accesses the application, thereby ensuring that a user receives up-to-date and accurate lending product offerings, which may change frequently along with fluctuations in interest rates and other market and business factors. Session continuity may thereby be maintained via centralized storage in the data store 102, enabling synchronized access to loan scenarios, budget data, and product pricing across sessions.

In order to generate the lending product offerings to be displayed to a user of the scenario builder micro application 130, the scenario information 122 may be input into a pricing engine 140 associated with a financial institution. The pricing engine 140 may be integrated to a loan origination system 142 of the financial institution, such that accurate lending product offerings may be determined in real time and provided to the scenario builder micro application 130. For instance, the scenario builder micro application 130 may orchestrate sequential and conditional service calls to various pricing, eligibility, and loan product systems associated with a financial institution. Then, upon either a prompt from a user or via an automated request, the micro application 130 may query the data store 102 for historical and session-specific financial data, retrieve applicable loan products via a pricing engine, and then stage rate calls by prioritizing pricing tiers and eligibility logic to generate the lending product offerings that are ultimately supplied to a user. Accordingly, the pricing engine may be configured to evaluate the eligibility of the prospective purchaser for numerous lending products before ultimately determining which product offerings are suitable for the particular lending scenario parameters. For instance, the pricing engine may generate multiple lending product offerings by applying the pricing engine to the lending scenario, wherein the additional lending product offering has a different term than the first lending product offering.

As mentioned, the pricing engine 140 may communicate with an existing loan origination system 142 of the financial institution, thereby allowing users to receive accurate lending product offerings without formally submitting an application or doing a soft credit pull (i.e., a user accessing the tool in a “guest” context). The pricing engine 140 may utilize a structured framework such as a pricing matrix that enables the financial institution to generate indicative lending product offerings based on limited, self-reported information of the lending scenario (e.g., loan amount, term, purpose, estimated credit score, and/or income range, etc.). The pricing matrix may be configured to integrate with existing loan origination systems (e.g., pricing and approval logic), such as via an application programming interface, to act as a front-end filter, whereby guest users may input their details, and the pricing engine may instantly consult the pricing matrix to generate tailored, non-binding lending product offerings from the existing loan origination systems. Again, if a user chooses to proceed with a particular lending product offering, a formal application may be provided and the front-end pricing matrix may no longer be used; instead, the actual origination system of the financial institution may then apply the more-comprehensive application process, verifying the user's information and recalculating terms as needed. This utilization of a front-end pricing engine may streamline the user experience by providing immediate feedback while ensuring that the financial institution's risk management and compliance protocols are maintained throughout the full origination workflow.

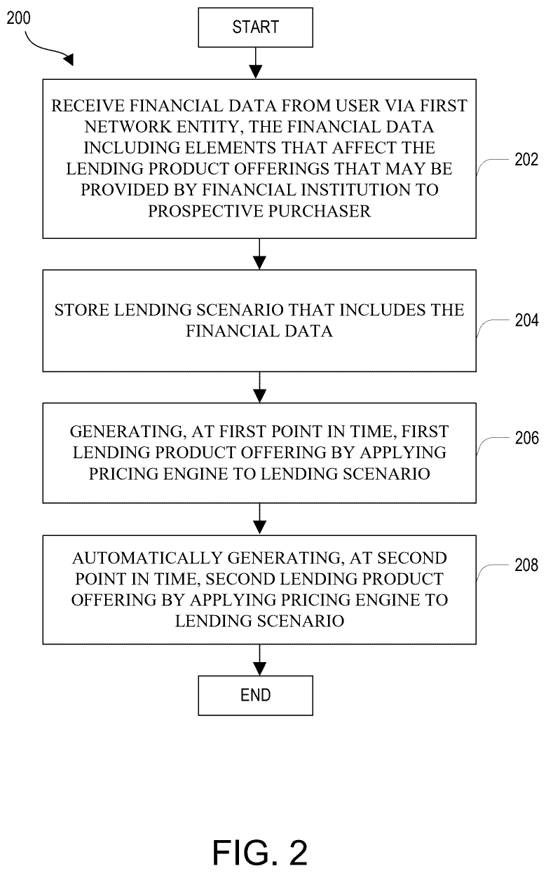

Consistent with FIG. 1, FIG. 2 depicts a method 200 of generating of lending product offerings from a stored lending scenario. Generally, the method may be performed by one or more processors executing computer-readable instructions stored by one or more computer storage media. At 202, financial data may be received from a user via a first network entity, the financial data including elements that affect the lending product offerings that may be provided by a financial institution to a prospective purchaser, which may be the user. At 204, a lending scenario that includes the financial data may be stored via a second network entity. At 206, a first lending product offering may be generated, at a first point in time, by applying a pricing engine to the lending scenario. And, at 208, a second lending product offering may be generated, at a second point in time, by applying the pricing engine to the lending scenario. Via this method and the systems described herein, a user may return to a scenario builder micro application and receive new lending offerings for the same lending scenario parameters that were previously researched on the account. The second lending product offering may therefore be generated using different interest rates, business policies, or other changes that have been accounted for by the pricing engine, compared to the first lending product offering at the earlier point in time.

Various aspects of the method 200 may be replicated to produce additional lending product offerings generated from alternative lending scenarios that a user researches. For instance, the method 200 may further include receiving a second set of financial data from a user, the second set of financial data similarly including elements that affect the lending offerings that may be provided by the financial institution to the prospective purchaser, storing a second lending scenario, and generating one or more additional lending product offerings by applying the pricing engine to the second lending scenario. As a few examples of ways that a user may produce a different lending scenario, the financial data of the second lending scenario may have a different maximum purchase price, down payment amount, credit score value, or payment goal relative to the financial data of the first lending scenario. As will be described, these various scenarios, as well as their associated lending product offerings, may all be presented, edited, and compared by a user via the scenario builder micro application. If a user decides to proceed further with any of the lending product offerings, the last-entered lending scenario may be collected and provided to a contact point of the financial institution, such as a mortgage loan officer.

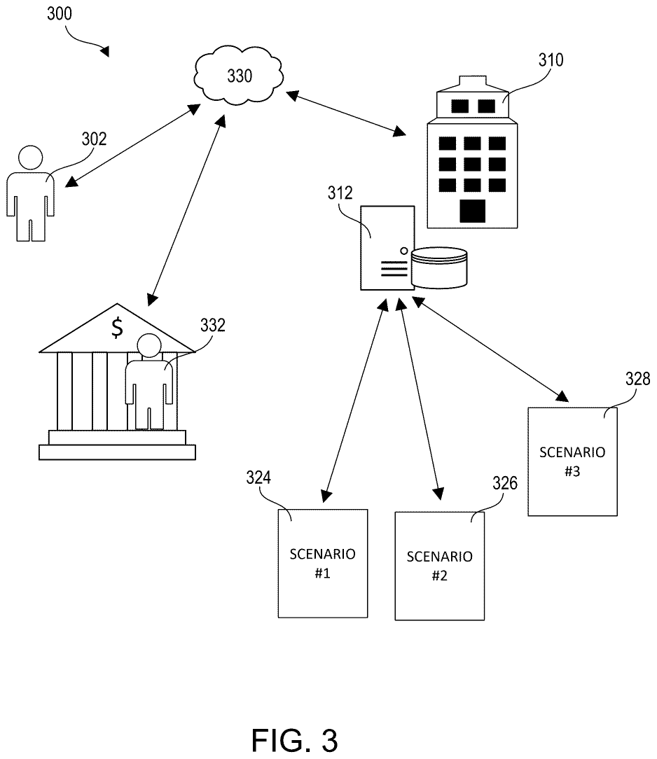

FIG. 3 depicts a banking system 300 handling the generation of a plurality of lending scenarios based on financial information supplied through various users. As previously discussed, because the scenario builder micro application may be configured to automatically generate up-to-date lending product offerings as rates change, a prospective purchaser 302 may start the process of analyzing lending products on one network entity and one point in time, and then continue the process on a second network entity at a later point in time, by simply logging in with their user credentials. Moreover, the user accessing the account may be an employee or agent 332 of the financial institution 310 (e.g., a mortgage loan officer), and the scenario builder micro application may be configured such that the employee or agent 332 may access the user's account, using one or more processors or data stores, and generate lending scenarios 324, 326, 328 on behalf of the prospective purchaser 302.

For example, a prospective purchaser 302 may access provide financial information to an employee or agent 332 at a physical branch of the financial institution. At this time, the scenario builder micro application may display, using a graphical user interface on a first network device, one or more lending product offerings 324, 326, 328 to the employee or agent 332, such as via a separate branch advisor scenario builder micro application, and that information may be communicated to the prospective purchaser 302. Then, at a later point in time, the prospective purchaser may access their account on the scenario builder micro application and the various scenarios 324, 326, and 328 may be automatically updated to reflect the current rates and the new lending products may be displayed to the prospective purchaser 302, such as via a graphical user interface on a second device connected to the network 330. In this way, the scenario builder provides a bi-directional, cross-context home lending planning framework that allows session state and scenario data portability between user environments. As discussed, various users (e.g., prospective purchasers, employees of the financial institution) may generate a lending scenario within the scenario builder micro application and subsequently continue or complete the session within an associated branch advisor tool, or vice versa.

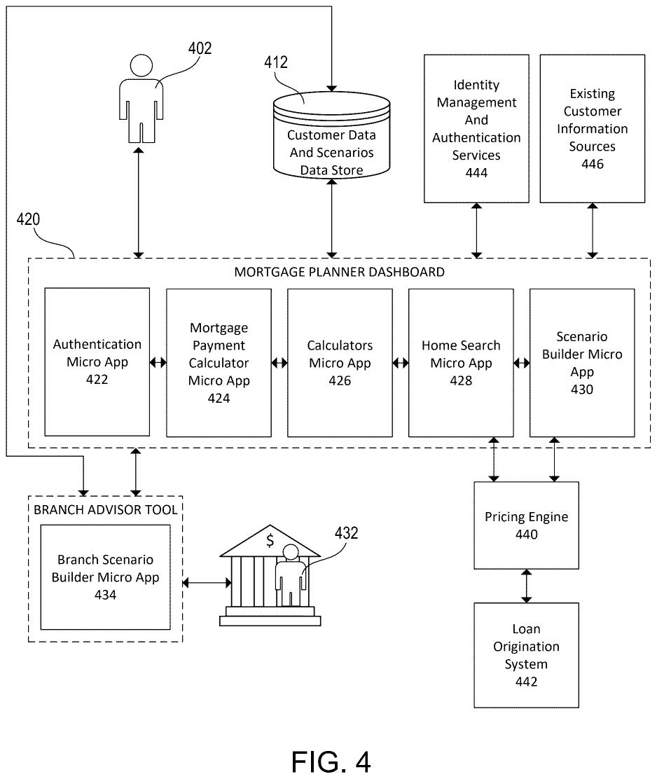

FIG. 4 depicts a banking system having a mortgage planner dashboard system 420 that communicates with various network entities to provide several interactive home purchasing tools. As shown, the mortgage planner dashboard 420 may include a plurality of micro applications that share data stored within a customer data and scenarios data store 412 to enable the generation of personalized home purchasing tools that may be accessed by a user 402. A branch advisor tool may include a branch scenario builder micro application 434 which, as previously discussed, may be utilized by an employee or agent 432 of the financial institution to modify existing lending scenarios or generate new lending scenarios that may be associated with the user's 402 account within the customer data and scenarios data store 412.

Generally, the micro applications within the mortgage planner dashboard 420 may share structured data through event-driven service calls. As one example, home listing data presented in the home listing micro app 430 can be stored within the customer data and scenarios data store 412 and then dynamically injected into a lending scenario within the scenario builder micro app 430, as will be further described. Each micro application may accesses the shared financial and user data to create personalized application outcomes that ensure consistent eligibility evaluation and pricing logic, with updates reflected in real time. In other words, by integrating each of the micro applications into a single system that collects and shares financial data, each micro application may provide tailored functionality to a user that would otherwise be unavailable were each application being operated on disparate systems.

The authentication micro application 422 may help to coordinate the authentication of user login information by verifying user credentials before granting access to a system (e.g., letting a user access their customized mortgage planner dashboard tools and saved lending scenarios and financial data). The authentication micro application 422 may present a login form where, for example, users enter their username or email and password and, upon submission, the credentials are securely transmitted to a backend authentication service that checks the credentials against the identity management and authentication services system 444 of the financial institution. If the credentials are valid, the authentication micro application 422 may generate a user session. The authentication micro application may be specifically configured to allow for guest sessions without requiring persistent user credentials. For example, a user may access the system without initially creating or logging into the account, and the financial data provided by such a guest user may still be used to access real-time inputs and services, such as accurate lending product offerings based on the provided financial information.

The mortgage payment calculator micro application 424 may receive user inputs such as annual gross income and monthly debt obligations to provide users with a more comprehensive assessment of their home loan affordability. The mortgage payment calculator micro application 424 may allow users to input their annual gross income, total monthly debt payments (such as car loans, credit cards, and student loans), along with other standard mortgage details like loan amount, interest rate, and loan term. The mortgage planner dashboard 420 may receive this information from other micro applications within the mortgage planner dashboard 420 or, in the event that the user 402 is an existing customer of the financial institution, from existing customer information sources 446 (e.g., prior account data) associated with the financial institution. The micro application 424 may use the financial information it receives to calculate financial ratios, such as the debt-to-income (DTI) ratio, which may be used to determine borrowing capacity. By factoring in both income and existing debts, the mortgage payment calculate micro application 424 may estimate the maximum mortgage amount a user can realistically afford, ensuring that monthly payments fit comfortably within their budget. The micro application 424 may display this information to a user, and also store and provide the financial data for use by other micro applications within the mortgage planner dashboard 424.

The calculators micro application 426 may include a suite of calculators that may be useful to prospective purchasers, such as an affordability calculator tool, an extra mortgage payments and amortization calculator, and a down payment calculator. Similar to the mortgage payment calculator micro application 424, these calculators may receive user inputs as well as from other micro applications within the mortgage planner dashboard 420 or from existing customer data collected by the financial institution.

The home search micro application 428 may enable users to find properties for sale based on specific criteria such as location, price range, property type, and desired features. The home search micro application 428 may receive property data from a service that has aggregated property listings from various sources, including multiple listing services, public records, real estate brokerages, as well as other sources, and display these property listings in a variety of formats, such as an augmented map or list. The home search micro application 428 may organize this data into a searchable database, allowing users to filter and sort results according to their preferences. In addition to providing property information such as, for example, photos, virtual tours, neighborhood statistics, and estimated property values, the home search micro application 428 may provide financial information about the property that is tailored to the specific user. For example, based on the listed price of the home, users may be able to view a monthly payment estimate, which may rely on information (e.g., down payment value, credit score, interest rate, loan term, etc.) that the user has selected or generated using one of the other micro applications within the mortgage planning dashboard 420.

The scenario builder micro application 430, as previously discussed, may allow users to input financial information and generate one or more lending scenarios that can each result in one or more lending product offerings being produced via a pricing engine 440 in communication with a loan origination system 442. As part of the scenario builder micro application, or as a separate micro application, a user may be prompted to input their credit score. Alternatively or additionally, the scenario builder micro application 430 may access a previously determined credit score that is accessible to the financial institution, provided that the user is a prior customer. The scenario builder micro application 430 may specifically function without a hard or soft credit pull, instead relying on the value provided by the user and generating the lending product offerings based on the provided value. In this manner, the scenario builder micro application 430 can generate accurate lending product offerings in real time by accessing the loan origination system 442 through a pricing engine 440, but without requiring the user to submit a formal application or undergo a soft credit pull.

The information collected and stored in the customer data and scenarios data store 412 may be accessed and used by other systems of the financial institution. As one example, the information in data store 412 may be used to generate a targeted marketing product, such as by using a stored lending scenario to determine a relevant product. For example, if a scenario associated with a user involves a low credit score, a targeted lending product (e.g., a credit card for individuals with low credit scores) may be selected for the user. As another example, if the scenario associated with a user involves a large maximum purchase price, a targeted lending product (e.g., a high-net-worth investment vehicle) may be selected for the user. The targeted marketing product may be linked to a user's account information, and may be provided to relevant systems within the financial institution for enactment.

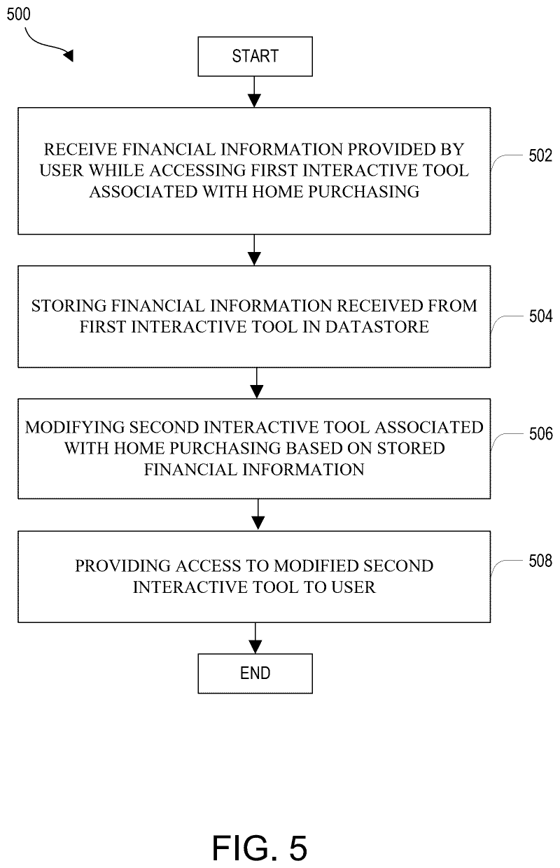

FIG. 5 depicts a computer-implemented method 500 of generating personalized home purchasing tools. At 502, financial information provided by a user may be received, via a processor, while accessing a first interactive tool associated with home purchasing. At 504, the financial information received from the first interactive tool may be stored in a data store. At 506, a second interactive tool associated with home purchasing may be modified, via a processor, based on the stored financial information. At 508, access may be provided, via a processor, to the modified second interactive tool to the user. Accordingly, the method 500 may allow for information received from one interactive tool, such as a micro application of the mortgage planner dashboard described herein, to be used to modify another interactive tool, such that the tool may be tailored to the user.

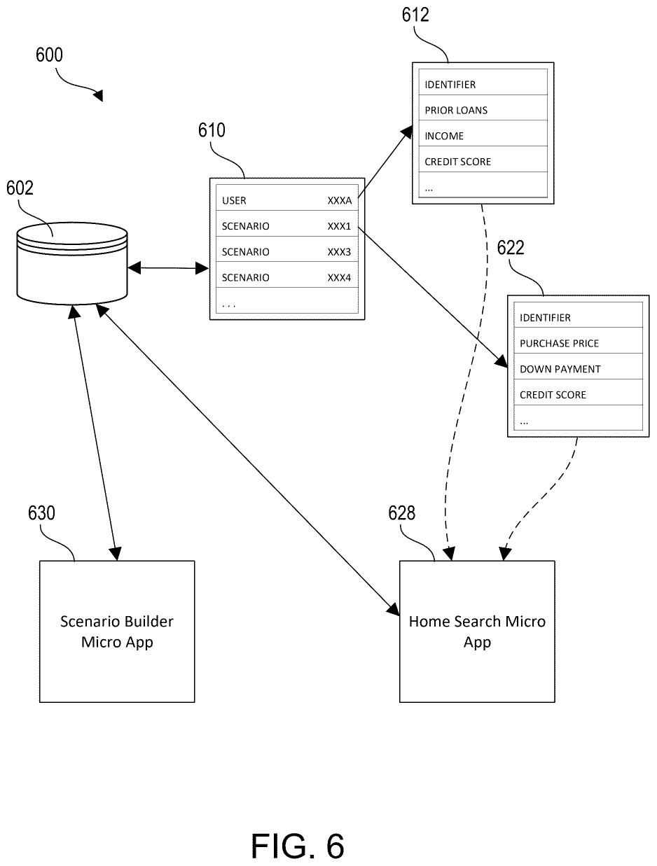

Consistent with FIG. 5, FIG. 6 depicts the generation of a personalized home search micro application 628 using information received from a scenario builder micro application 630. As shown, the scenario builder micro application 630 may receive and generate various information 610 associated with a user as well as specific lending scenario data packages, which may be stored in data store 602. The user information 612 may include, for example, a user identifier, prior loan information associated with the user, income, and credit score information. Each of the lending scenario data packages may include, for example, lending scenario identifiers, a maximum purchase price, a down payment value, a credit score, as well as other information relevant to determining a lending product offering. The home search micro application 628 may retrieve the information 610 received from the scenario builder micro application 630 and stored within the data store 602, and the home search micro application 628 may use this information to tailor its functionality.

There are numerous ways that information received from the scenario builder micro application 630 may be used to modify the home search micro application 628. For example, based on a maximum purchase price received from a the scenario builder micro application 630, a search tool within home search micro application 628 may remove, flag, or otherwise indicate to the user which property listings are below or above that maximum purchase price. As another example, the financial information associated with each property, such as a projected monthly payment amount, may be calculated using the information received from the scenario builder micro application 630, such as a credit score, interest rate, down payment, or other relevant factor.

It should be appreciated that other micro applications of the mortgage planning dashboard described herein may be similarly modified. For example, information from the home search micro application 628 may be used to modify the scenario builder micro application 630, such as by automatically prompting a user to generate a new, or automatically modify an existing, lending scenario based on the price of a selected property listing in the home search micro application. In this manner a user may seamlessly progress through the various integrated tools. For instance, a user may choose to start by first determining a maximum purchase price using the mortgage payment calculator, before progressing to generate lending scenarios via the scenario builder micro application, and then ultimately reviewing property listings that match those generated scenarios on the home search micro application. Alternatively, a user may start by selecting a property on the home search micro application, and then seamlessly work back to determine the credit score or income that would be needed to receive a lending product offering that would match the selected property.

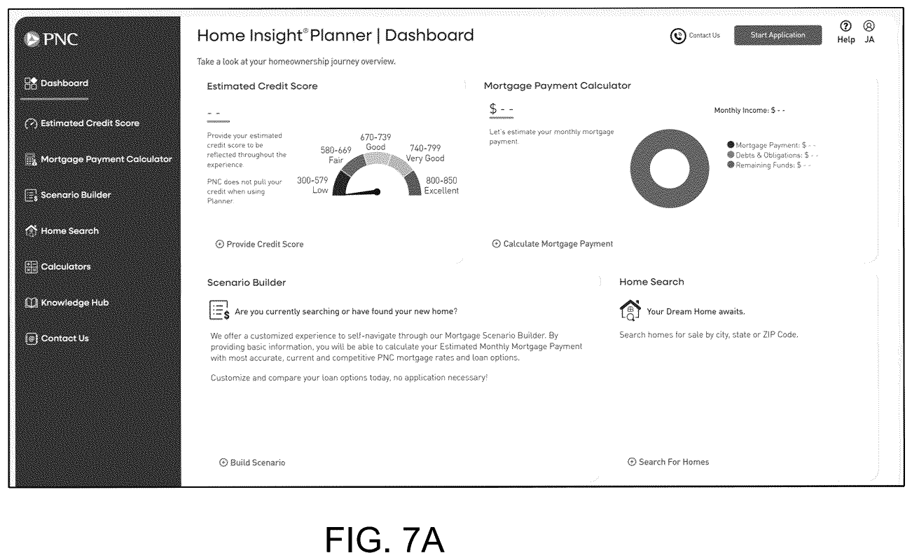

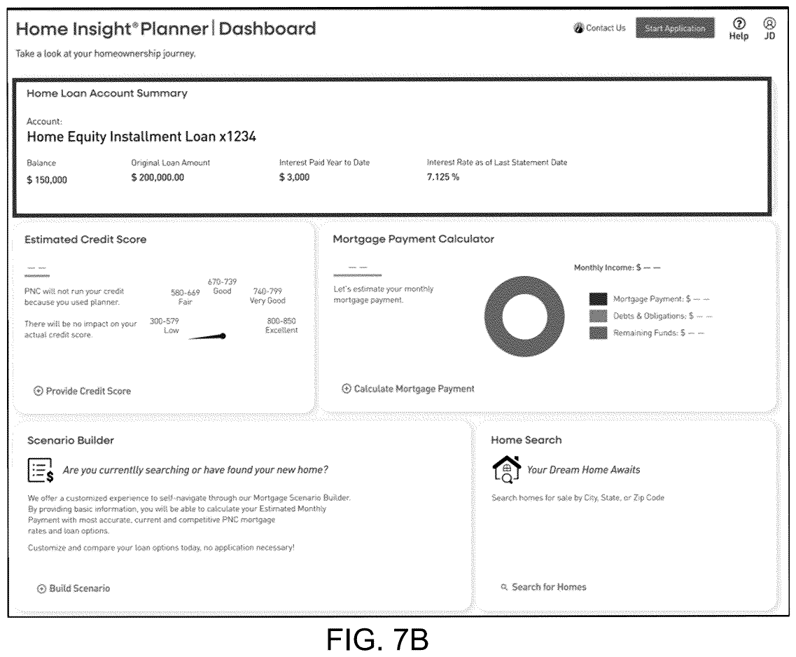

Consistent with the systems and methods described herein, FIGS. 7A-7B depict graphical user interfaces of an example mortgage planner dashboard system having several integrated interactive tools. As shown, the home page of the mortgage planner dashboard system may display relevant information, including information that may be generated from the various interactive tools listed in the righthand column (e.g., estimated credit score, mortgage payment calculator, scenario builder, home search, calculators, etc.), to a user, potentially including information of past accounts associated with a user (FIG. 7B). A user may choose what order to progress through the various micro applications, which may share data with each other as well as the overall dashboard to be displayed on the home page. As can be seen in FIG. 7A, the default system for a first time user may display interfaces corresponding to the various micro applications, but without any data. As a user progresses through the tools and provides information, these home page interfaces may then populate with data. For a returning user, past information, such as prior lending scenarios may automatically populate.

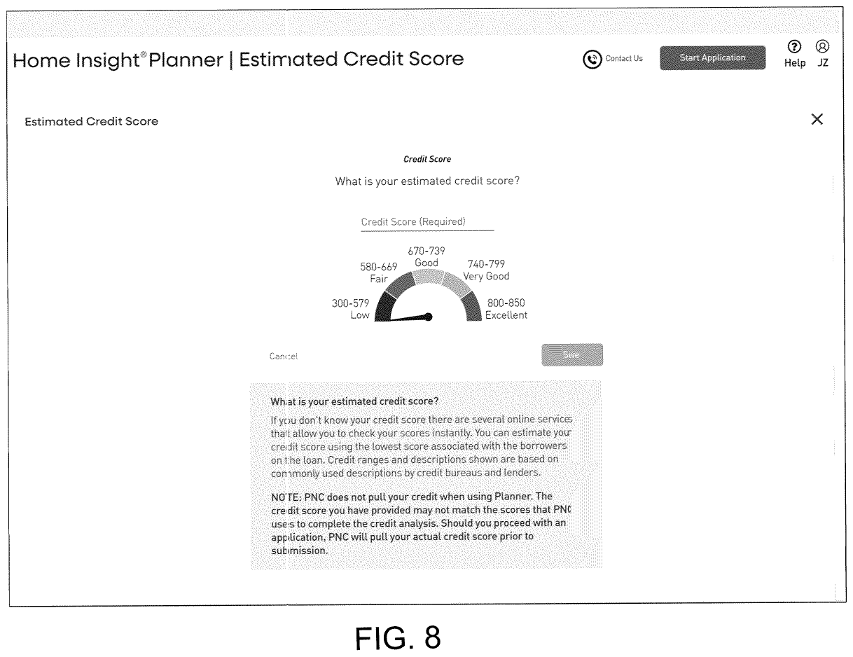

FIG. 8 depicts an “Estimated Credit Score” tool of the mortgage planner dashboard system of FIG. 7A. The estimated credit score tool may prompt a user to submit an estimated credit score, which may then be stored and associated with the user account (either existing or new) to assist with the customization of other micro applications in the dashboard. As previously mentioned, the scenario builder may be configured to produce real-time lending product offerings without the financial institution pulling the credit score.

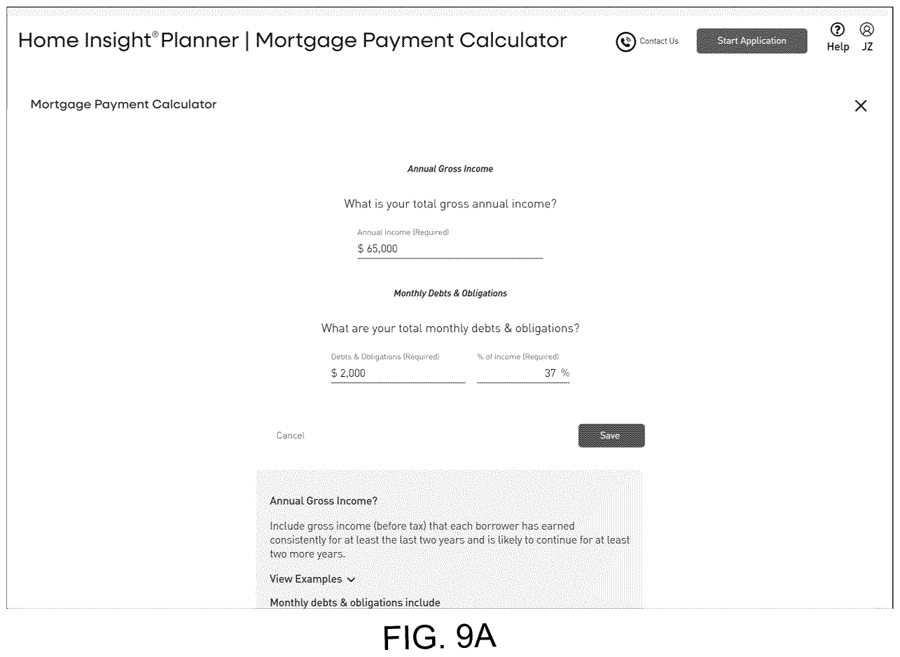

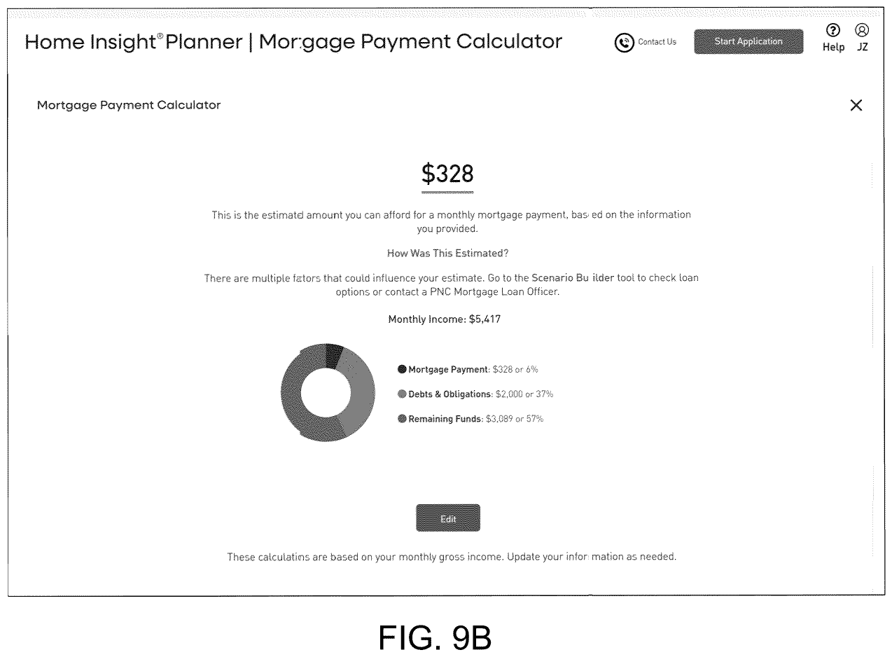

FIGS. 9A-9B depict a “Mortgage Payment Calculator” tool of the mortgage planner dashboard system of FIG. 7A. As shown, users may input relevant values such as income, and monthly debt obligations, and the system may be configured to produce an estimated mortgage payment that the user can afford, such as by limiting the user to a particular debt-to-income ratio selected by the financial institution.

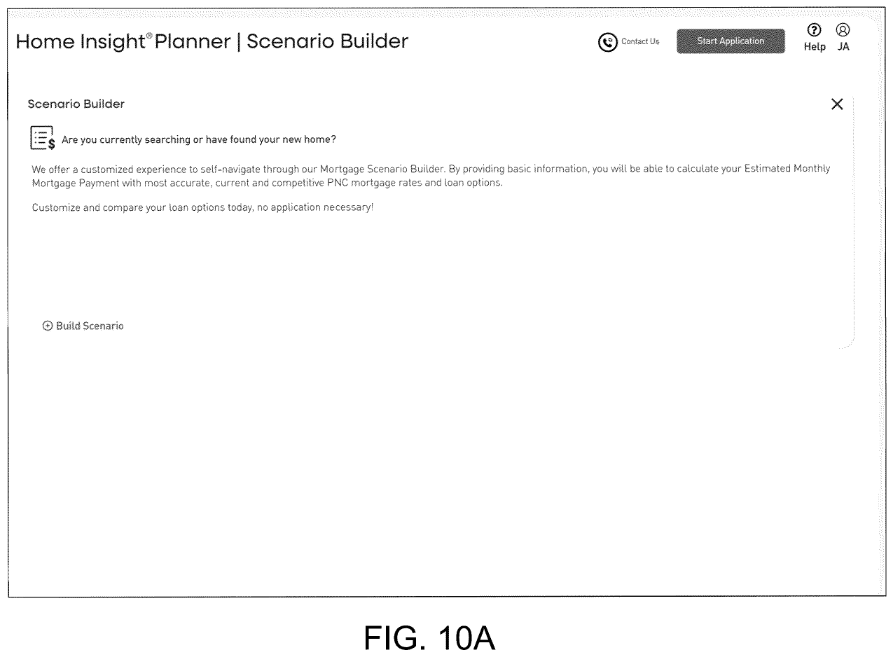

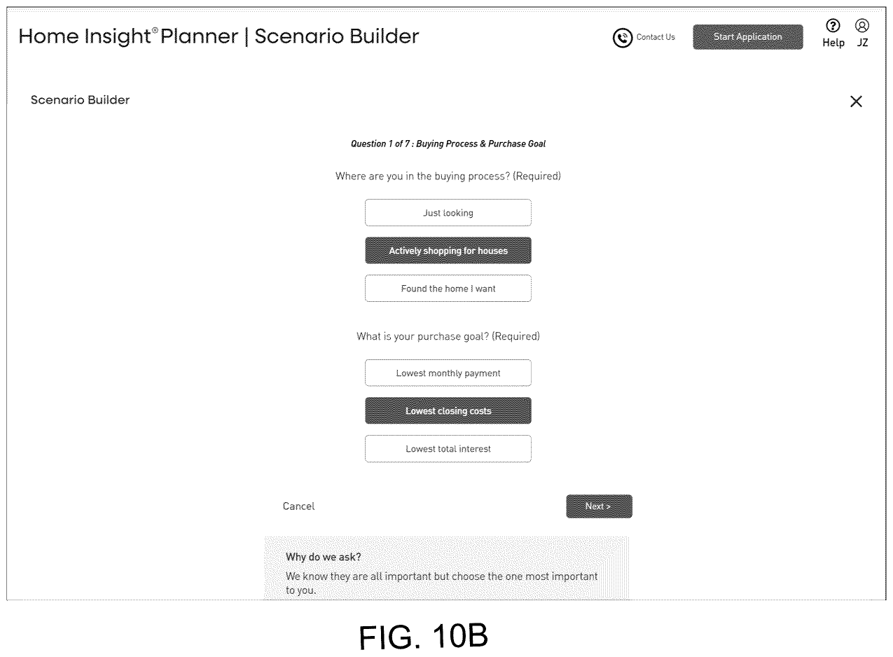

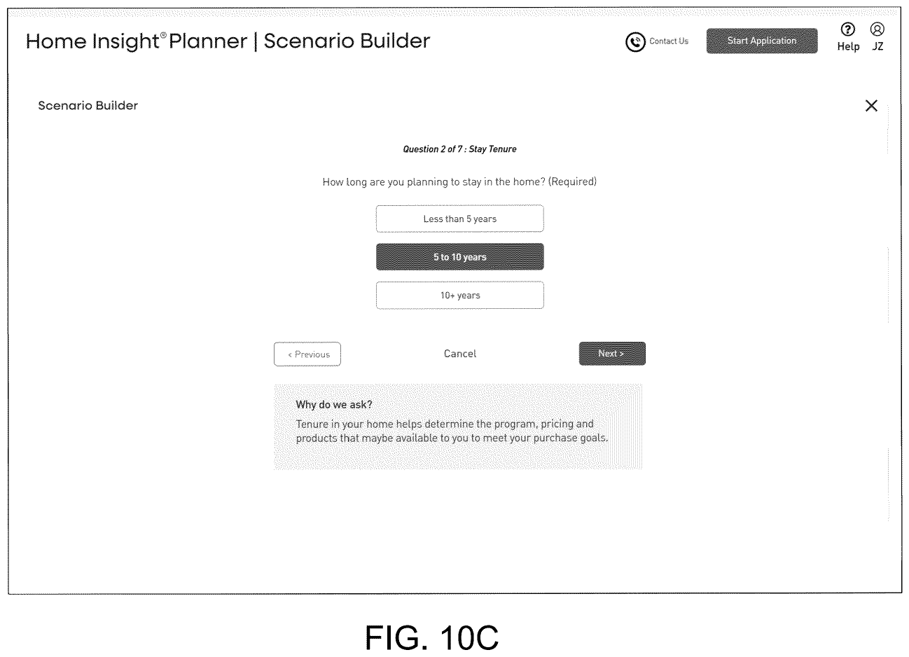

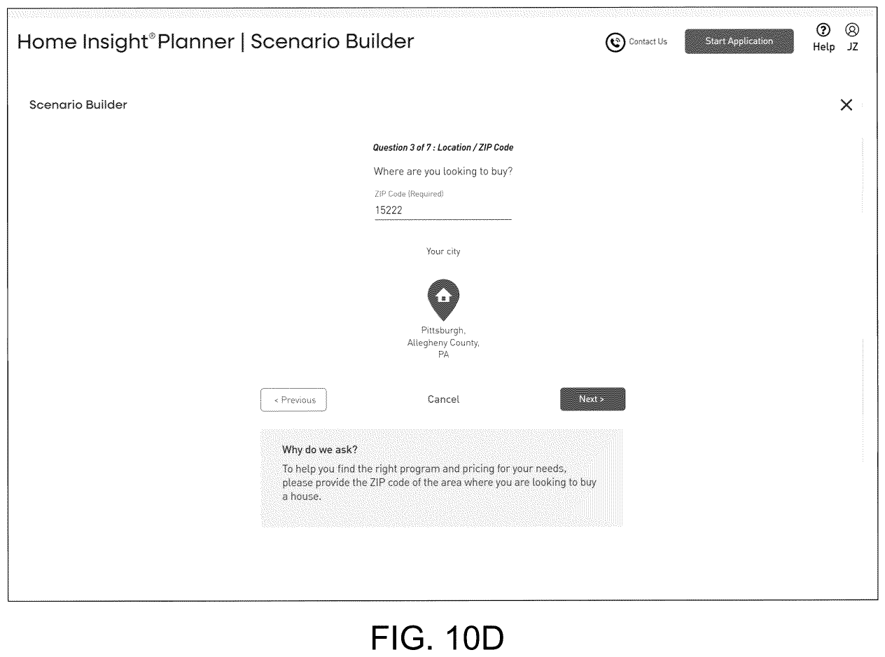

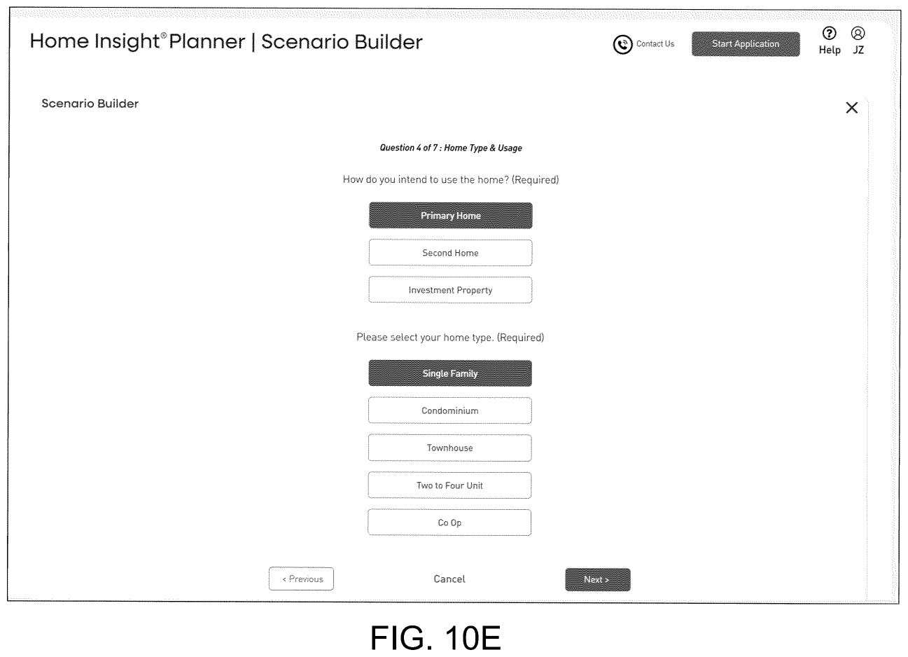

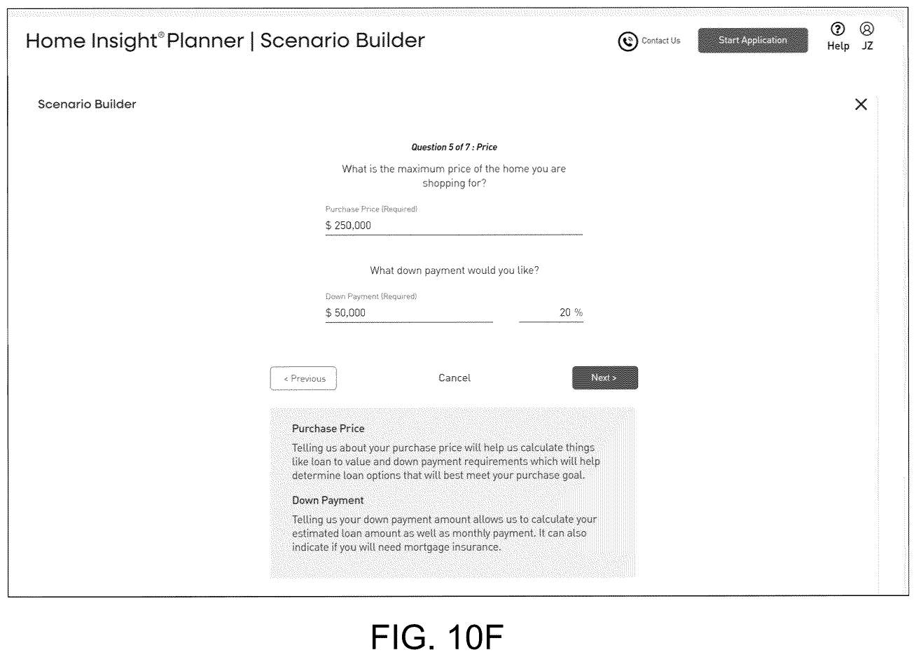

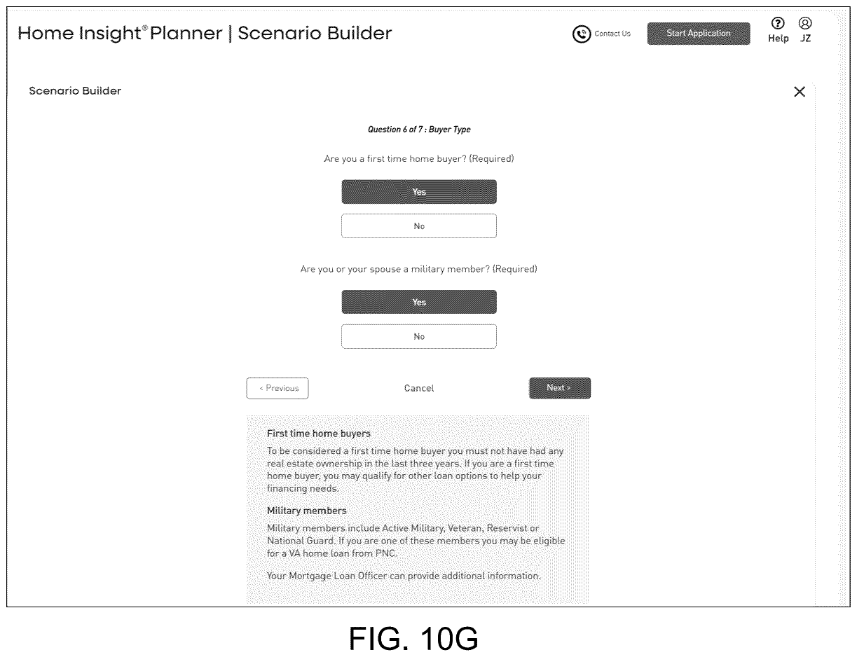

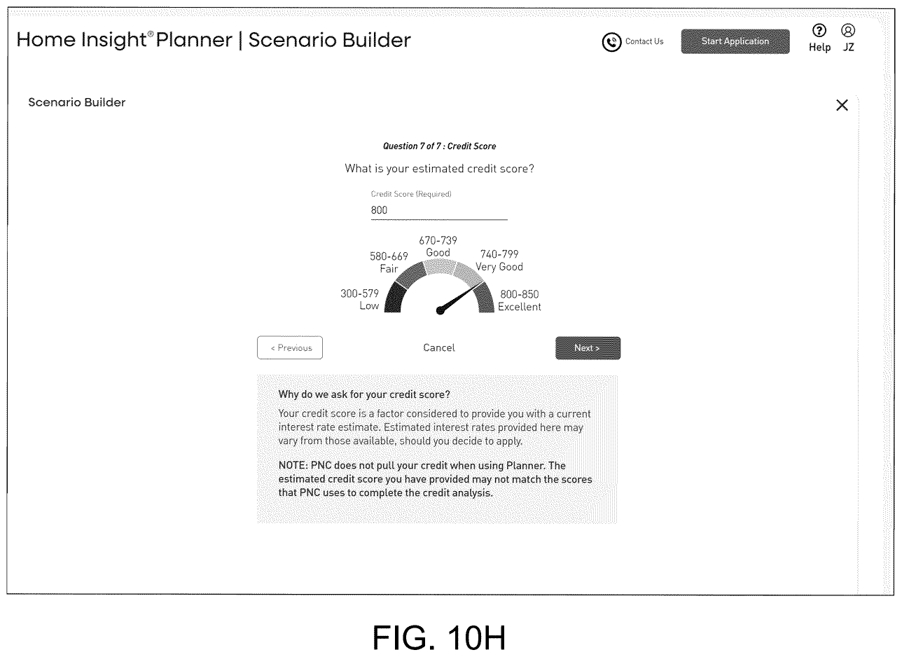

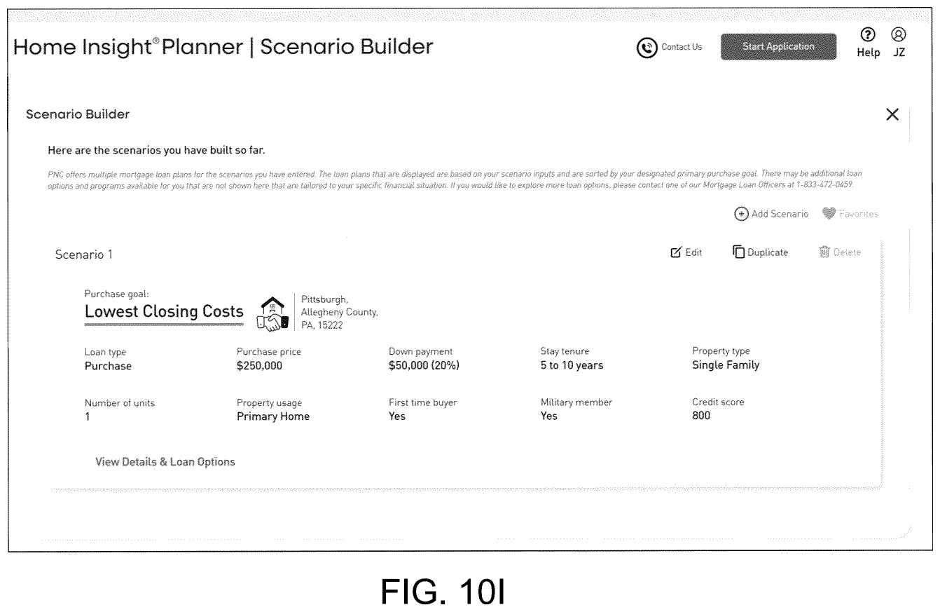

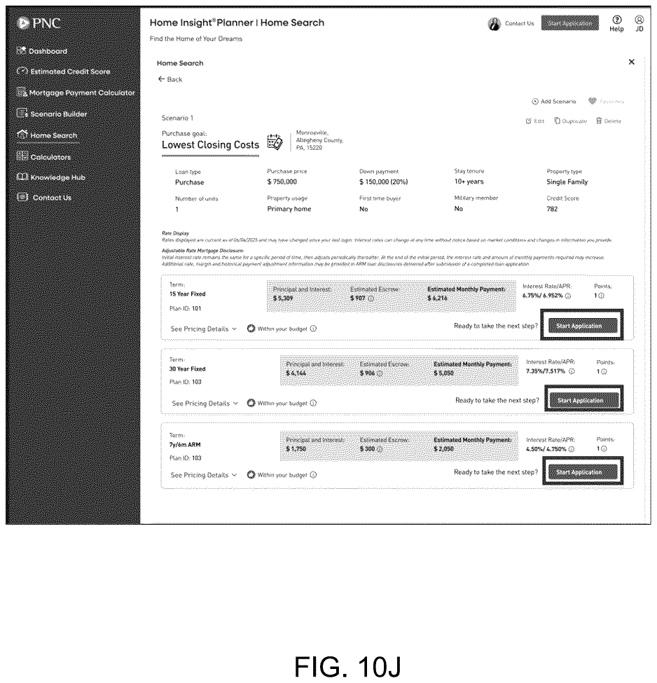

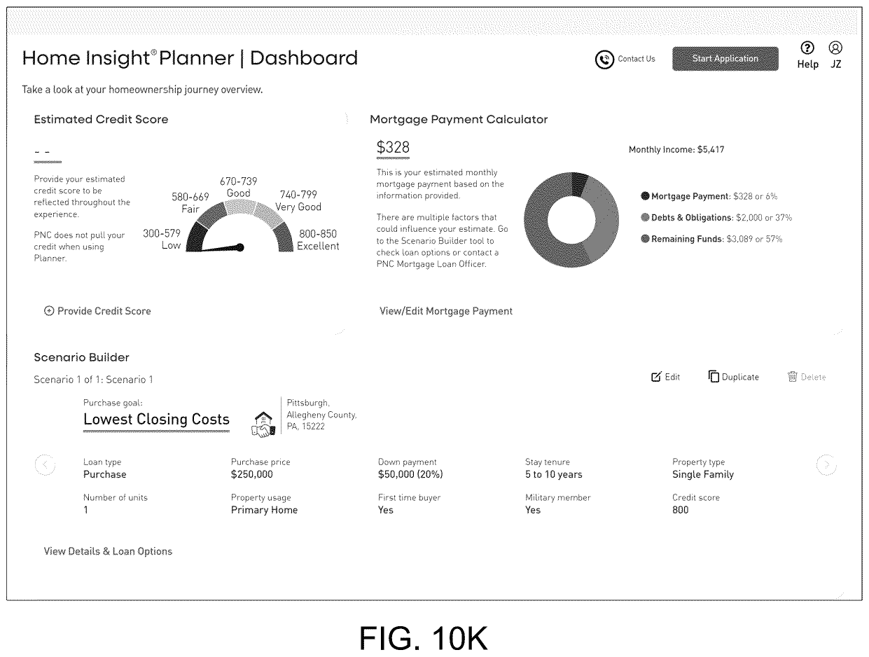

FIGS. 10A-10K depict a “Scenario Builder” tool of the mortgage planner dashboard system of FIG. 7A. FIGS. 10B-10H depict a series of user input pages of a “Scenario Builder” tool of the mortgage planner dashboard system of FIG. 7A. As shown, users may be prompted to input various information relevant to generating lending product offerings, such as the user's buying process and purchase goal, stay tenure, location, home type and usage, price, buyer type, and credit score, as well as other information that may be needed for a financial institution to generate a lending product offering. FIG. 10I depicts a scenario listing page showing “Scenario 1,” which specifies the data that is associated with that scenario. A user may generate multiple lending scenarios, and view the available lending product offerings associated with each scenario by selecting the “View Details & Loan Options” feature. FIG. 10J is a diagram depicting a mortgage offerings listing page of “Scenario 1.” As shown, multiple different lending product offerings may be presented to a user, including information associated therewith, like term, principal and interest, estimated escrow, estimated monthly payment, inter rates, points, etc. Users may be prompted to start an application for any of these lending product offerings in the scenario. FIG. 10K is a diagram depicting the mortgage planner dashboard system home page now displaying information associated with the generated scenario in this example.

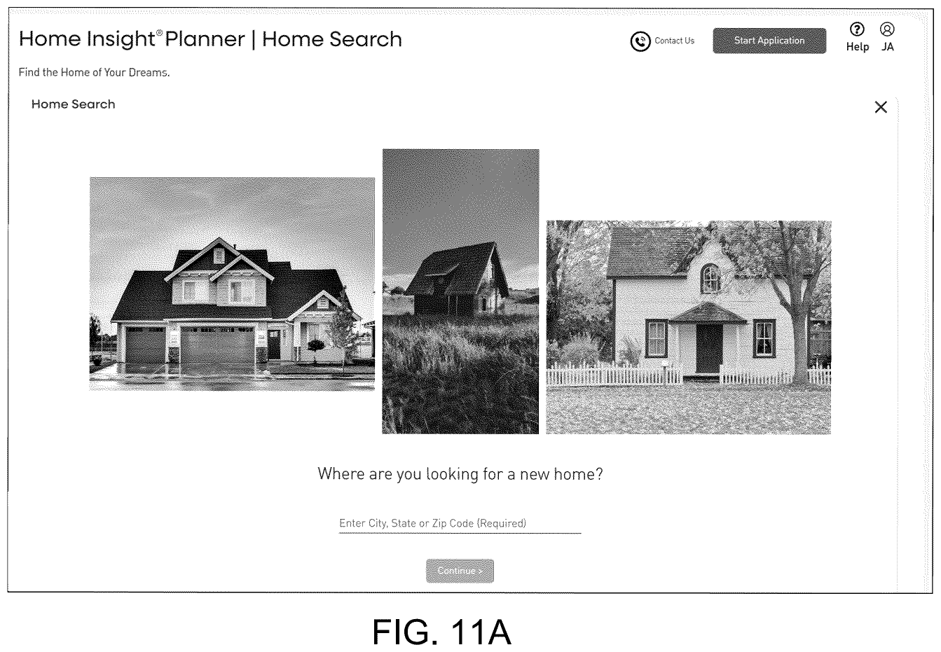

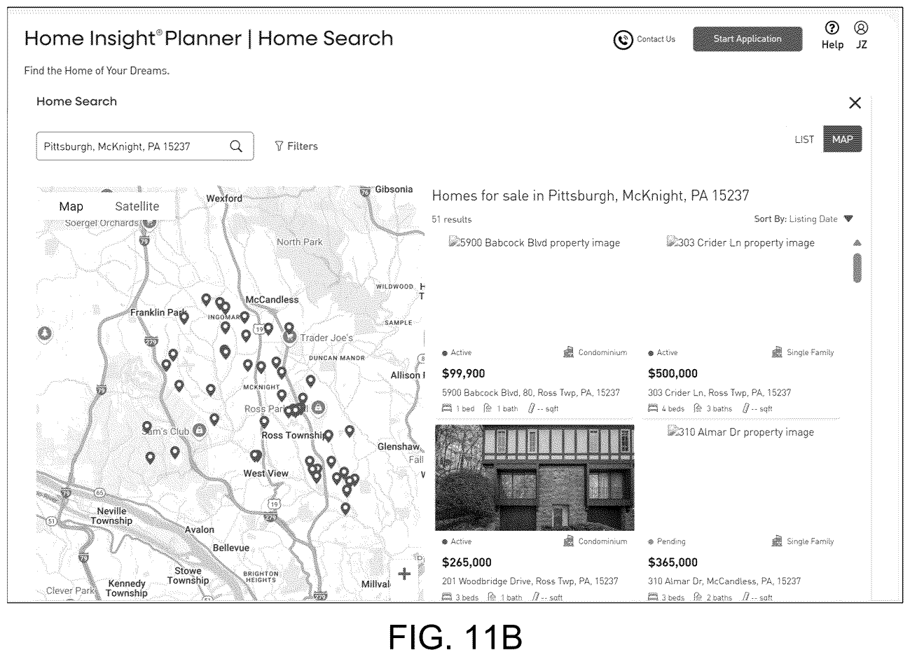

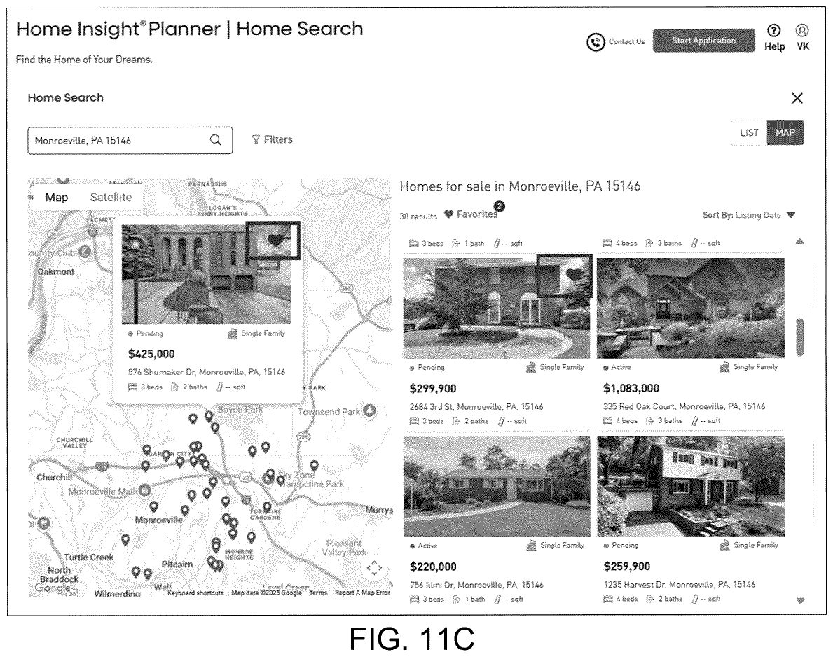

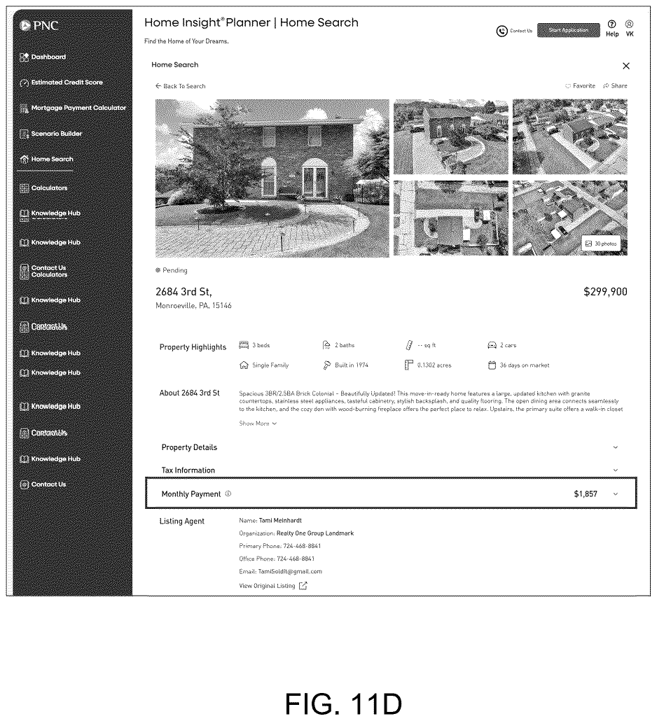

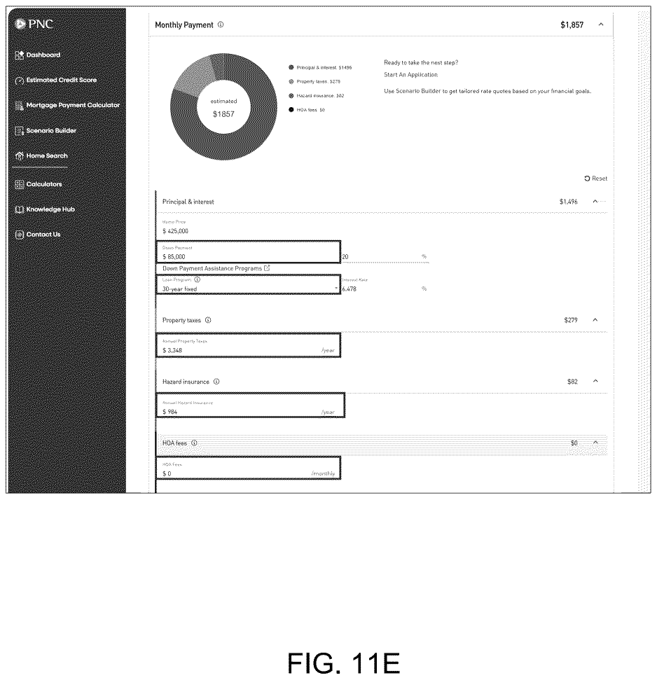

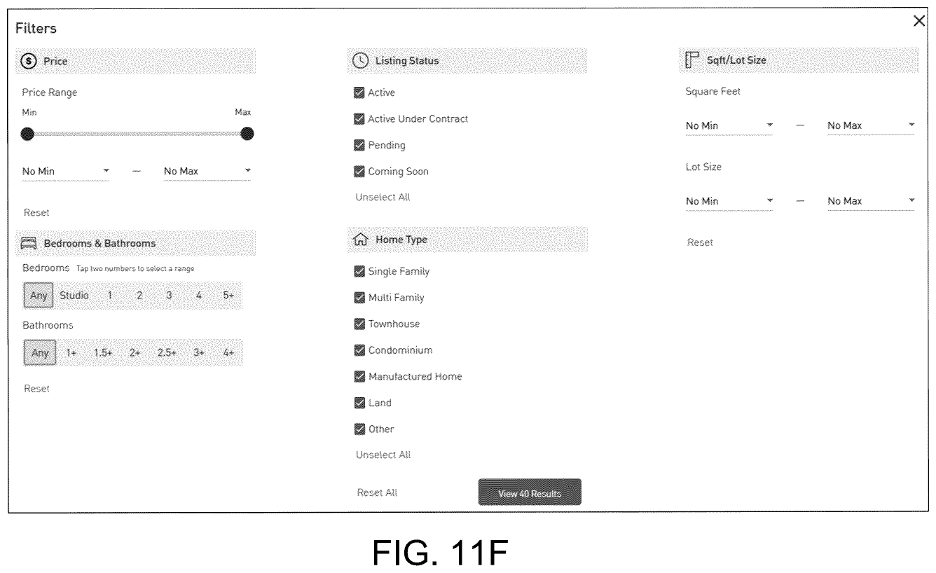

FIGS. 11A-11F depict a “Home Search” tool of the mortgage planner dashboard system of FIG. 7A. Users may initiate a search, such as by providing a search location, and the search results may be displayed to the users (FIGS. 11B-11D). The home search micro application may be configured to allow users to select, filter (FIG. 11F), and favorite (FIG. 11C) or even save specific properties for later review. As previously discussed, the search results may be tailored depending on, for example, a maximum home purchase amount determined by another micro application of the mortgage planner dashboard. The home search micro application may present financial information associated with a property listing, which may be tailored based on financial information received from other micro applications, as previously discussed. The monthly payments section of the home search tool may display, for example, an estimated payment and allow the user to change fields such as the down payment, loan program, property taxes, hazard insurance, and HOA fees and view the updated estimated monthly payment. The view may default to a set amount, as displayed, such as a 30-year fixed mortgage with an assumed FICO of 740.

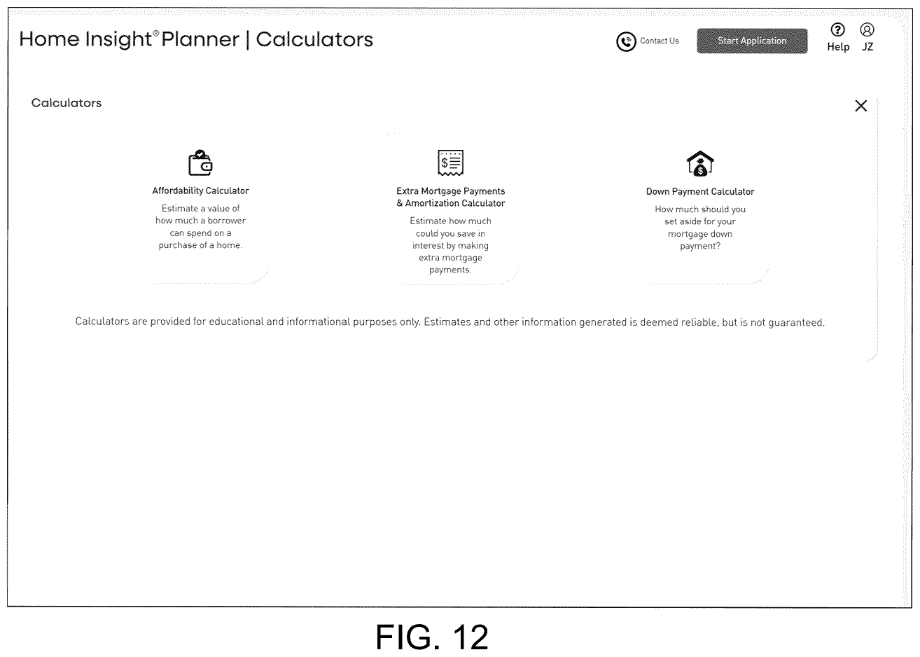

FIG. 12 is a diagram depicting a start page of a “Calculators” tool of the mortgage planner dashboard system of FIG. 7A. As shown, a user may further access an affordability calculator tool, an extra mortgage payments and amortization calculator, and a down payment calculator using this micro application. All of these tools may receive information from users and be relied on to configure other micro applications within the mortgage planner dashboard.

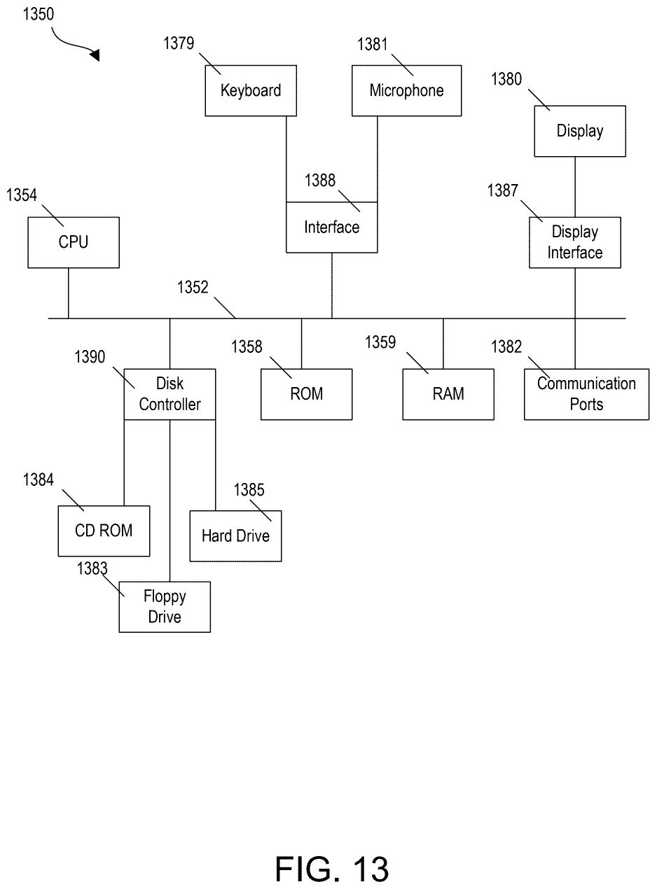

FIG. 13 is a diagram depicting an example system for implementing the approaches described herein for lending scenario generation and storage as well as the integrated tools of the mortgage planner dashboard. FIG. 13 depicts a block diagram of exemplary hardware for a standalone computer architecture 1350 that may be used to include and/or implement the program instructions of the various aspects of the present disclosure. A bus 1352 may serve as the information highway interconnecting the other illustrated components of the hardware. A processing system 1354 labeled CPU (central processing unit) (e.g., one or more computer processors at a given computer or at multiple computers) may perform calculations and logic operations required to execute a program. A non-transitory processor-readable storage medium, such as read only memory (ROM) 1358 and random access memory (RAM) 1359, may be in communication with the processing system 1354 and may include one or more programming instructions for preventing unauthorized access to a computing system. Optionally, program instructions may be stored on a non-transitory computer-readable storage medium such as a magnetic disk, optical disk, recordable memory device, flash memory, or other physical storage medium.

In FIG. 13, computer readable memories and data stores may include one or more data structures for storing and associating various data used in the example systems. For example, a data structure stored in any of the aforementioned locations may be used to store data from XML files, initial parameters, and/or data for other variables described herein. A disk controller 1390 interfaces one or more optional disk drives to the system bus 1352. These disk drives may be external or internal floppy disk drives such as 1383, external or internal CD-ROM, CD-R, CD-RW, or DVD drives such as 1384, or external or internal hard drives 1385. As indicated previously, these various disk drives and disk controllers are optional devices. Each of the element managers, real-time data buffers, conveyors, file input processors, database indices shared access memory loader, reference data buffers, and data managers may include a software application stored in one or more of the disk drives connected to the disk controller 1390, the ROM 1358, and/or the RAM 1359. The processor 1354 may access one or more components as required.

A display interface 1387 may permit information from the bus 1352 to be displayed on a display 1380 in audio, graphic, or alphanumeric format. Communication with external devices may optionally occur using various communication ports 1382. In addition to these computer-type components, the hardware may also include data input devices, such as a keyboard 1379, or other input device 1381, such as a microphone, remote control, pointer, mouse, and/or joystick.

Generally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, or JAVA, for example, or any other suitable programming language. Other implementations may also be used, however, such as firmware or even appropriately designed hardware configured to carry out the methods and systems described herein.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. Moreover, while illustrative embodiments have been described herein, the scope includes any and all embodiments having equivalent elements, modifications, omissions, combinations (e.g., of elements across various aspects), adaptations, and/or alterations based on the present disclosure. The elements in the claims are to be interpreted broadly based on the language employed in the claims and are not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and, accordingly, all suitable modifications and equivalents may be resorted to, falling within the scope of the disclosure.

In general, it will be apparent to one of ordinary skill in the art that some of the aspects as described hereinabove may be implemented in many different embodiments of software, firmware, and/or hardware. For example, the embodiments described hereinabove may be implemented in computer software using any suitable computer software language. Such software may be stored on any type of suitable computer-readable medium or media, such as, for example, a magnetic or optical storage medium. Thus, the operation and behavior of the aspects are described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the present embodiments may be executed by programmable equipment, such as computers. Software that may cause programmable equipment to execute the processes may be stored in any storage device, such as, for example, a computer system (nonvolatile) memory, an optical disk, magnetic tape, or magnetic disk. Furthermore, some of the processes may be programmed when the computer system is manufactured or via a computer-readable medium. Such a medium may include any of the forms listed above with respect to storage devices as well as others. The computing systems described herein can be generally controlled and coordinated by operating system software, such as iOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file systems, networking, and I/O services, and provide a user interface functionality, such as a graphical user interface (“GUI”), among other things.

Furthermore, although aspects of the disclosed embodiments may be associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above-described examples, but instead are defined by the appended claims in light of their full scope of equivalents.

While the disclosure has been described in detail and with reference to specific embodiments thereof, it will be apparent to one skilled in the art that various changes and modifications can be made therein without departing from the spirit of the embodiments. Thus, it is intended that the present disclosure cover the modifications and variations of this disclosure provided they come within the scope of the appended claims and their equivalents.

1. One or more computer storage media storing computer-readable instructions that when executed by one or more processors, cause the one or more processors to perform operations comprising:
receiving data from a user via a first network entity, the data including elements that affect the product offerings that may be generated by an institution;
storing, via a second network entity, a data package that includes the received data;
generating, at a first point in time, a first product offering by applying a pricing engine to the data package; and
automatically generating, at a second point in time, a second product offering by applying the pricing engine to the data package.

2. The computer storage media of claim 1, wherein the received data is financial data that includes elements that affect lending product offerings that may be provided by a financial institution to a prospective purchaser, the data package is a lending scenario that includes the financial data, and the first and second product offerings are lending product offerings, and wherein the pricing engine is configured to evaluate the eligibility of the prospective purchaser for a plurality of lending products.

3. The computer storage media of claim 2, wherein the second lending product offering is generated using a different interest rate compared to the first lending product offering.

4. The computer storage media of claim 2, wherein the financial data includes a maximum purchase price, a down payment amount, and a credit score value.

5. The computer storage media of claim 2, wherein the processor operations further comprise:
receiving a second set of financial data from a user, the second set of financial data including elements that affect the lending offerings that may be provided by the financial institution to the prospective purchaser;
storing a second lending scenario that includes the second set of financial data; and
generating an additional lending product offering by applying the pricing engine to the second lending scenario.

6. The computer storage media of claim 5, wherein financial data of the second lending scenario has a different maximum purchase price, down payment amount, or credit score value relative to the financial data of the first lending scenario.

7. The computer storage media of claim 2, wherein the user is an employee or agent of the financial institution, and the financial information is provided to the user by the prospective buyer.

8. The computer storage media of claim 7, wherein the processor operations further comprise:
displaying, using a graphical user interface on a first device, the first lending product offering to the user at the first point in time; and
displaying, using a graphical user interface on a second device, the second lending product offering to the prospective buyer at the second point in time.

9. The computer storage media of claim 2, wherein generating the first and second lending product offerings includes providing information to the pricing engine regarding prior lending products associated with the prospective purchaser.

10. The computer storage media of claim 9, wherein the prior account of the user is a prior lending account.

11. The computer storage media of claim 2, wherein user is the prospective purchaser.

12. The computer storage media of claim 2, wherein the processor operations further comprise:
modifying, at the request of the user, the lending scenario; and
generating a third lending product offering by applying the pricing engine to the modified lending scenario.

13. The computer storage media of claim 2, wherein the processor operations further comprise:
generating, at the first point in time, an additional lending product offering by applying the pricing engine to the lending scenario, wherein the additional lending product offering has a different term than the first lending product offering.

14. The computer storage media of claim 2, wherein the processor operations further comprise:
generating a targeted marketing product using the stored lending scenario.

15-20. (canceled)

21. A computer-implemented method performed by one or more processors, the method comprising:
receiving data from a first user via a first network entity, the data including elements that affect the product offerings that may be generated by an institution;
storing a data package that includes the received data;
generating, at a first point in time, a first product offering by applying a pricing engine to the data package; and
receiving data from a second user via a second network entity, the data including elements that affect the product offerings that may be generated by an institution;
modifying the data package to include the received data from the second user;
automatically generating, at a second point in time, a second product offering by applying the pricing engine to the modified data package.

22. The method of claim 21, wherein the first network entity is located at a branch of a financial institution.

23. The method of claim 21, wherein the received data is financial data that includes elements that affect lending product offerings that may be provided by a financial institution to a prospective purchaser, the data package is a lending scenario that includes the financial data, and the first and second product offerings are lending product offerings, and wherein the pricing engine is configured to evaluate the eligibility of the prospective purchaser for a plurality of lending products.

24. The method of claim 21, wherein generating the first and second lending product offerings includes providing information to the pricing engine regarding prior lending products associated with the prospective purchaser.

25. The method of claim 24, wherein the prior account of the user is a prior lending account.

26. A system for generating product offerings via a pricing engine, the system comprising:
means for receiving data from a user via a first network entity, the data including elements that affect the product offerings that may be generated by an institution;
means for storing, via a second network entity, a data package that includes the received data;
means for generating, at a first point in time, a first product offering by applying a pricing engine to the data package; and
means for automatically generating, at a second point in time, a second product offering by applying the pricing engine to the data package.
